(19) United States
(12) Patent Application Publication
(10) Pub. No.: US 2013/0277302 A1
(43) Pub. Date: Oct. 24, 2013

(54) WATER TREATMENT SYSTEM

(71) Applicants: Klaus Doelle, Syracuse, NY (US); Steve Giarrusso, Minoa, NY (US); David L. Johnson, Syracuse, NY (US)

(72) Inventors: Klaus Doelle, Syracuse, NY (US); Steve Giarrusso, Minoa, NY (US); David L. Johnson, Syracuse, NY (US)

(21) Appl. No.: 13/803,777

(22) Filed: Mar. 14, 2013

Related U.S. Application Data
(60) Provisional application No. 61/637,501, filed on Apr. 24, 2012.

(51) Int. Cl. C02F 3/02

(52) U.S. Cl. CPC C02F 3/02
USPC 210/609; 210/150; 210/151; 210/620

(57) ABSTRACT

A treatment system for removing a plurality of pollutants from wastewater includes a removal device for removing a plurality of gross solids from the wastewater, an aeration device for reducing a biochemical oxygen demand (BOD) and a chemical oxygen demand (COD) of the wastewater and a bioreactor containing a bacterial biofilm, said bioreactor including a plurality of cells configured for operation on a predetermined drain fill cycle.

### CROSS REFERENCE TO RELATED APPLICATIONS

This is a non-provisional application based upon U.S. Provisional Patent Application Ser. No. 61/637,501, entitled “WATER TREATMENT SYSTEM”, filed Apr. 24, 2012, which is incorporated herein by reference.

### BACKGROUND OF THE INVENTION

1. Field of the Invention

The present invention relates to a wastewater treatment system which removes pollutants from a variety of wastewater effluents, storm water runoff or other grey water and/or leachate and, further, to a method for treating wastewater.

2. Description of the Related Art

An unfortunate byproduct of the advance of technology and the expansion and development of society has been a corresponding increase in the production and release of pollutants into the biosphere, particularly into the water supply. Point sources and non-point sources of such pollutants include domestic residences, commercial properties, industrial and agricultural sources. In response to public health and safety concerns, the Clean Water Act was passed in 1972 by the U.S. Congress, establishing the goals of eliminating the release of high quantities of toxic substances into the water supply and ensuring that surface water was of a sufficient quality to be safe for sport and recreational use. Subsequently, in 1974 the Safe Drinking Water Act was passed, requiring the Environmental Protection Agency (EPA) to set and enforce standards for safe drinking water quality. In addition to legislative and regulatory pressure for improved waste management and the identification of a more sustainable system for wastewater treatment, the environmental management industry has also been subjected to economic pressure to improve efficiency in the form of increased energy and material costs.

What is needed in the art is a more efficient and sustainable system for the effective removal of pollutants from wastewater prior to its reintroduction into the natural environment.

### SUMMARY OF THE INVENTION

The present invention provides a treatment system for removing a plurality of pollutants from wastewater. Wastewater, in the context of the present invention, is understood to include storm water runoff, agricultural runoff and wastewater, municipal wastewater, food and pharmaceutical industry process wash water, hydraulic fracturing process water, hydrocarbon spills, airport runoff, and other carbon, nitrogen and/or phosphorous containing fluids. The treatment system according to the present invention includes a removal device for removing gross solids from the wastewater and an aeration device for reducing the biochemical oxygen demand (BOD) and the chemical oxygen demand (COD) of the wastewater. The treatment system according to the present invention further includes a bioreactor including a bacterial biofilm and a plurality of cells configured for operation on a predetermined drain fill cycle.

The present invention further provides an additional embodiment of a treatment system for removing a plurality of pollutants from wastewater. According to the present invention, the treatment system includes a removal device for removing gross solids from the wastewater and an aeration device for reducing the biochemical oxygen demand and chemical oxygen demand of the wastewater. Additionally, at least one reactor containing a bacterial biofilm and a plurality of cells configured for operation on a predetermined drain fill cycle is provided for removal of additional contaminants and further reduction of the BOD and COD.

Additionally, the present invention provides a method of treating wastewater to remove a plurality of pollutants. The method includes the steps of removing gross solids from the wastewater and, further, aerating the wastewater to reduce the biochemical oxygen demand and the chemical oxygen demand of the wastewater. The wastewater is then passed through at least one reactor, such as a bioreactor, including a bacterial biofilm and a plurality of cells operated on a predetermined drain fill cycle.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic illustration of a wastewater treatment system according to the present invention in general;

FIG. 2 is a schematic illustration of the wastewater treatment system according to the present invention;

FIG. 3 is a flow chart of an embodiment of a process for treatment of wastewater according to the present invention;

FIG. 4 is a schematic illustration of a segmented biofilm reactor management train according to the present invention; and

FIGS. 5a-e are schematic illustrations of recirculation configurations for a wastewater treatment system having a plurality of reactors.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

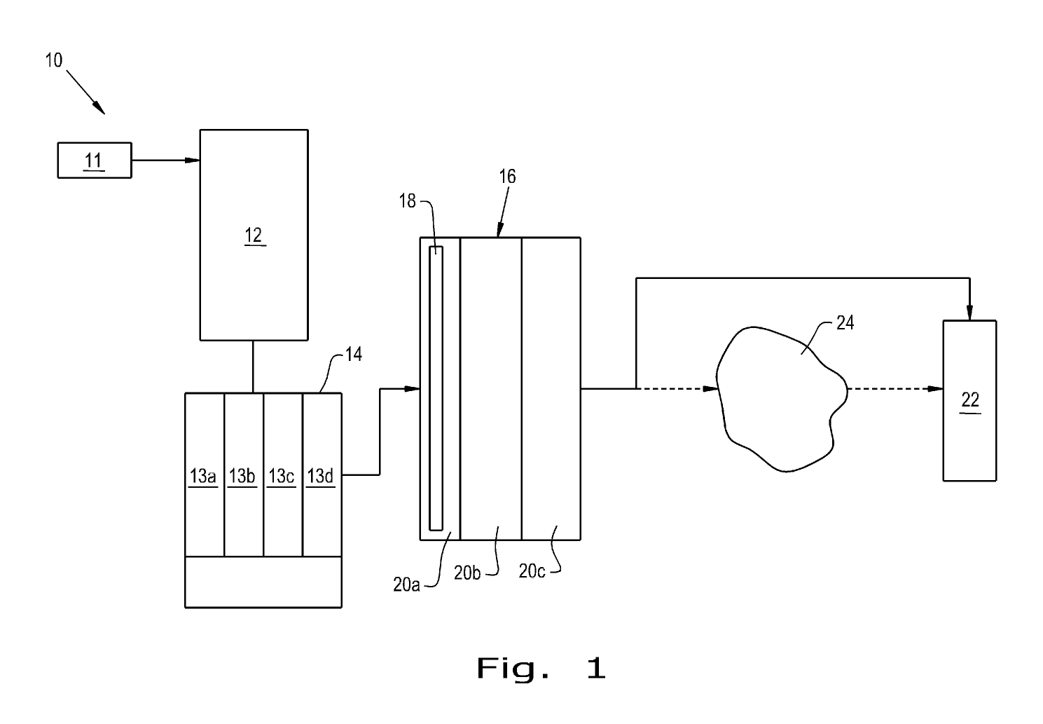

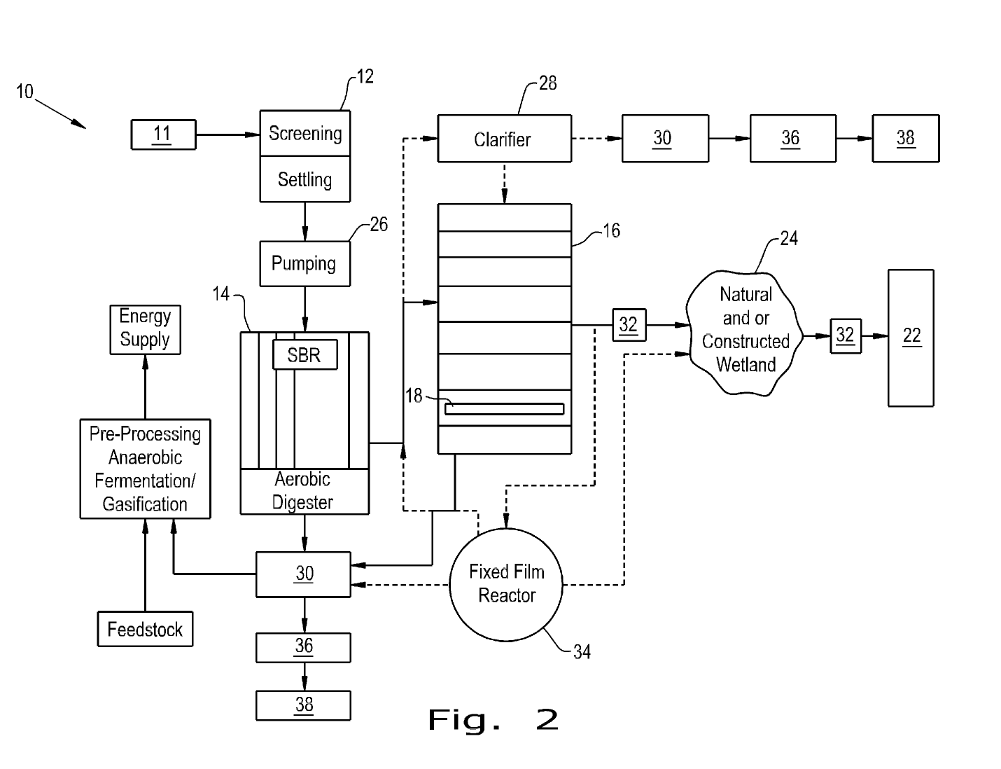

Referring now to the drawings, and more particularly to FIGS. 1 and 2, there is shown wastewater treatment system 10, which generally includes a removal device 12 for removing gross solids from the wastewater, an aeration device 14 for reducing the biochemical oxygen demand (BOD) and the chemical oxygen demand (COD) from the wastewater, and at least one reactor 16, for example a bioreactor 16, containing a bacterial biofilm 18. The at least one reactor 16 is configured to remove a plurality of contaminants from the wastewater including, for example, nitrogen, phosphorous, polychlorinated biphenyl (PCB), hydrocarbons and/or pharmaceutical, as well as other organic contaminants. Bioreactor 16 includes a plurality of cells 20a, 20b, 20c configured for operation on a predetermined drain fill cycle. The plurality of cells may, for example, be three cells including a first cell 20a, a second cell 20b and a third cell 20c. In such a case, at a point during the predetermined drain fill cycle, first cell 20a and second cell 20b may be online and third cell 20c offline for a predetermined period of time. More specifically, first cell 20a and second cell 20b are operated on an alternating fill and drain cycle appropriate to the workforce availability and the wastewater loading rate for the system. Third cell 20c then remains offline for a predetermined time such as between 0 to 40 days, for example 20 to 40 days, during which an anaerobic layer at the bottom of the cell is actively consuming the particulate organic material that builds up from normal operation of the system. After the expiration of the predetermined time period, third cell 20c then re-enters the drain and fill sequence while another cell, for example first cell 20a or second cell 20b, is taken offline for bio- solids management. According to the present invention, there may be any number of cells, for example more than three cells.

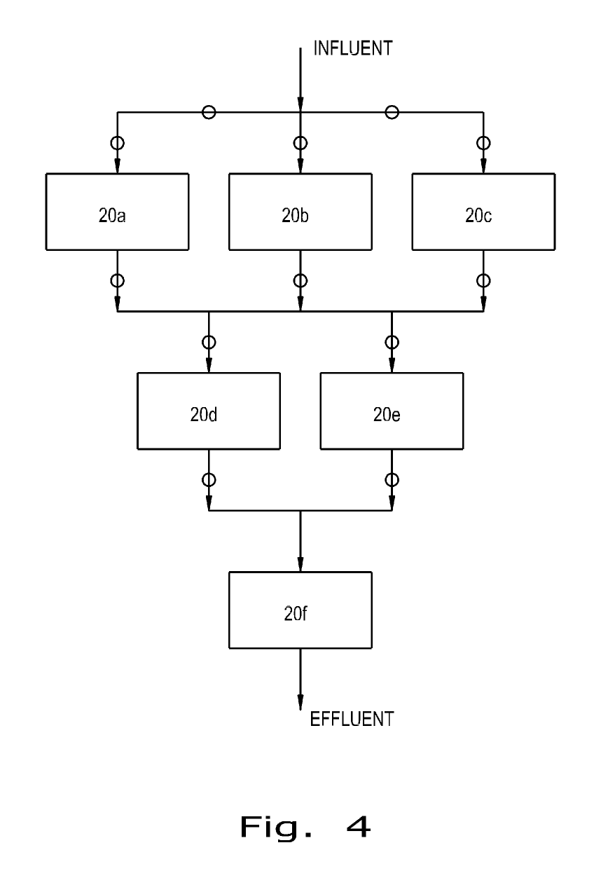

Referring now to FIG. 4, there is shown an embodiment of a bioreactor biofilm management train. Cells 20a, 20b and 20c are in the first tier of treatment in bioreactor 16. As set forth above, two of these cells can be online and operating on a predetermined drain fill cycle and the third cell could be offline. After passing through at least one of the first tier cells, the wastewater is transported to cells 20d and 20e in a second tier of the train with one or both cells being online and operating on a predetermined drain fill cycle. Then, after passing through at least one of the second tier cells, the wastewater is transported to cell 20f before proceeding to an aquifer or to the next treatment stage. The drain fill cycle may range between 0 and 40 days, for example between 0 and 20 days or between 20 and 40 days.

The reactor 16 is also configured to operate within an ORP range of between −250 mV and +1200 mV. Reactor 16 may also be configured to operate within a dissolved oxygen range of between 0 and 50.0 milligrams per liter (mg/L).

According to the present invention, the untreated wastewater enters the treatment system through inflow 11 which transports the wastewater into removal device 12 for removing gross solids. Removal device 12 is configured for raking, screening, settling, sedimentation, filtration and/or flocculation to remove the gross solids from the wastewater. More specifically, device 12 removes large particulates and debris, biological solids, metals (dissolved and/or particulate) and nutrients (dissolved and/or particulate). Removal device 12 may be in the form of a screening device such as a bar screen with a cleaning apparatus or a settling device such as a grid removal device for removal of heavy particles such as a settling chamber and cleaner.

From removal device 12, the wastewater, less the gross solids, is transported to aeration device 14. The transportation of the wastewater throughout treatment system 10 may be accomplished, for example, gravitationally or through pumping. For example, pump 26 illustrated in FIG. 2 is an impeller pump, positive displacement pump or an Archimedes screw. Aeration device 14 is configured for bubbling oxygen through the wastewater to reduce the BOD and COD to make it suitable for discharge to the next treatment stage. Aeration device 14 may be in the form of a sequential batch reactor, a fixed film reactor, a trickling filter and/or a membrane filter. If, for example, aeration device 14 is a sequential batch reactor (SBR), the SBR may include a plurality of alternated reaction chambers 13a, 13b, 13c and 13d. Reactor/SBR 14 may include any number of reaction chambers. For example, the SBR may have at least one reaction chamber in a settle/decant mode and at least one other reaction chamber in an aerating/filling mode. It is also possible to have an SBR including only one reaction chamber. Alternatively or in addition to an SBR, aeration device 14 may include an aerated lagoon system, settling pond(s), air activated mixing tanks and/or a settling tank.

From aeration 14, the wastewater effluent is transported to bioreactor 16 for further reduction of the biological oxygen demand and the chemical oxygen demand and removal of additional contaminants. Bioreactor 16 may further be configured for removal of nitrogen, phosphorous, polychlorinated biphenyl (PCB), hydrocarbons and/or pharmaceutical compounds. Bioreactor 16 contains at least one bacterial biofilm 18 and includes a plurality of cells 20a, 20b, 20c configured for operation on a predetermined drain fill cycle. The bacterial biofilm is supported on a suitable mineral, plastic or other media, over which is passed the wastewater to be treated. The submersion of the bacterial biofilm is controlled such that it is constantly or periodically submerged in the wastewater effluent, dependent upon the predetermined drain fill cycle. The redox environment of the aqueous phase within certain segments or regions of the biofilm is controlled by the varying degrees of presence or absence of dissolved oxygen derived either through contact with air, pure oxygen or other defined gas phase containing a suitable oxygen concentration derived from chemical or electrochemical processes, in balance with rates of biological withdrawal of oxygen from the aqueous phase in support of metabolic processes. The natural bacterial population of the biofilm is an assemblage of numerous species whose ability to metabolize substrate in the presence or absence of oxygen spans the range of obligate aerobe to facultative aerobe/aneaerobe to obligate anaerobe.

Advantageously, the present invention provides a treatment system and a method for treating wastewater which provides for the continuous microbiological treatment of wastewater to a) enhance the disintegration and degradation of complex organic compounds, converting organic nitrogen to ammonia and mineralizing organic- and poly-phosphate to orthophosphate; b) remove biological oxygen demand (BOD) by conversion of the organic matter to carbon dioxide; c) convert ammonia to nitrate by nitrification; d) diminish or remove nitrate by de-nitrification conversion to nitrogen gas; and e) remove phosphate by precipitation or chemisorptions on a suitable substrate. The sequence of hierarchical biologically and chemically mediated reactions may be carried out on the bacterial biofilm 18, for example a continuous linear biofilm apparatus, within which the oxidation-reduction potential (ORP) of contiguous segments is controlled to optimize the metabolism of specific groups of the biofilm bacterial consortia. In other words, specific groups of the biofilm bacterial consortia are segregated, physically and/or spacially, on the apparatus.

The wastewater treatment system and method of treating wastewater according to the present invention provide a mechanism for controlling the optimum distribution of bacterial species for treatment of wastewater in the biofilm continuum, whereby maintenance of the ORP conditions in the contiguous segments of the microbial reactor leads to a differing spatial distribution of the organisms. Dissolved oxygen concentration is the chief controlling variable of the redox potential associated with the aqueous environment surrounding the biofilm, exhibiting a standard potential of greater than +1200 mV for the pH dependent reduction of oxygen to water. Oxygen is also a required substrate, and metabolic requirement, for the aerobic conversion of dissolved organic matter (BOD or COD), to carbon dioxide, as well as the oxidation of ammonia to nitrate. Phosphorous released in this decomposition, primarily as orthophosphate, can be attenuated by adsorption to iron rich phases present in the support media, provided this occurs sufficiently downstream in the treatment process that the low ORP values needed to reduce iron (III) to iron (II), or to from sulfide from sulfate are not encountered. Thus, by controlling the redox potential in specific segments of the microbial biofilm through manipulation of the dissolved oxygen concentration, the hierarchical sequence of wastewater treatment reactions can be effected in, for example, a continuous, flow-through biofilm reactor.

By controlling the optimum conditions for bacterial metabolism in different portions of the bacterial biofilm 18, the populations of key organisms are enhanced, or cultured, from the natural assemblage. By maintaining these constant optimum conditions through ORP gradients or regimes, in concert with managing the substrate delivery rates and sequences, the various specialized segments of the bacterial biofilm 18 can be established in manner similar to zone refining.

As a result of the use of the bacterial biofilm 18 according to the present invention, nitrogen removal through nitrification-denitrification can be accomplished across all seasons without diminution during cold weather months, for example by isolation and spatial concentration of two distinct strains of nitrifying organisms. One of the two strains, for example, operates more effectively during warm weather periods, while the second strain operates more effectively during cold weather, with a seamless transition between the two groups and no or substantially no hysteresis.

Bacterial biofilm 18 may, for example, be in the form of a continuous linear biofilm apparatus including a plurality of contiguous segments configured to operate to control an oxidation-reduction potential (ORP) of biofilm 18 and a metabolism of each of the plurality of bacterial species. In other words, according to one embodiment of the present invention, physical means are provided to alter the ORP, causing different bacterial components of the treatment system to undertake and enhance contaminant removal. For example, the ORP may be in a range between −400 millivolts (mV) and +400 mV, for example between −200 mV and +200 mV.

Referring now to FIG. 2, there is shown an embodiment of wastewater treatment system 10. As shown in FIG. 2, wastewater treatment system 10 according to the present invention provides that prior to and/or after the wastewater is, for example continuously, passed through bioreactor 16, it may be passed through a clarifier 28 for removal of additional biosolids, particulate matter and other contaminants. These contaminants, for example in the form of sludge, may be further processed using a sludge thickening apparatus 30 such as a settling chamber, screw press, belt press and/or centrifuge.

According to one embodiment of the present invention, bioreactor 16 is in the form of a subsurface, horizontal flow fixed film, vegetated submerged bed (VBS) including a plurality of cells 20a, 20b and 20c configured for operation on the predetermined drain fill cycle, as illustrated in FIG. 1. In this case, there may be multiple bacterial biofilms 18 positioned in the VBS cells. For example, there may be at least one bacterial biofilm 18 in each of the cells 20a, 20b and 20c. It is feasible, however, according to the present invention to have a plurality of bacterial biofilms 18 and a plurality of bioreactor cells 20a, 20b and 20c, but not have as many biofilms 18 as there are cells. In other words, there may be cells which do not include a bacterial biofilm 18.

Upon completion of treatment of the wastewater in the bioreactor, the clean water may be discharged into an aquifer 22 or further processed to remove additional contaminants. Aquifer 22 may be in the form of a creek, river, stream, channel lake, sea and/or ocean.

Wastewater treatment system 10 according to the present invention may further include at least one wetland 24 incorporated into the system before and/or after the bioreactor. The at least one wetland 24 can be either a natural wetland or a constructed wetland. Natural wetlands can be characterized as marshes and swamps. Constructed wetlands, however, are manmade inland ecosystems that can be characterized as marshes and swamps comprising a specific soil condition and vegetation that is flood resistant. Water is present in both types of wetlands at the root level of the vegetation and/or at the surface area. Their unique ecosystem makes them applicable for green infrastructure projects that deal with runoff problems associated with urban and rural settings.

Prior to and/or after the at least one wetland 24, the treatment system according to the present invention may further include a disinfection unit 32, as illustrated in FIG. 2. Disinfection unit 32 operates using ultraviolet (UV) light or chemical disinfection to remove potentially harmful microbes from the wastewater. In addition, the wastewater may further be deodorized in order to make it potable.

The wastewater treatment system according to the present invention may further include a fixed film reactor 34 for further reduction of BOD and/or COD and/or phosphorous and/or nitrogen and/or ammonia in the wastewater. After passing through fixed film reactor 34, treated wastewater may then pass directly to aquifer 22 or through wetland 24 before proceeding to aquifer 22. Particulate and solids removed from the wastewater in fixed film reactor 34 may then be passed through to sludge thickening apparatus 30 before being dispatched to storage 36 and or a landfill 38. The thickened sludge may also be incinerated. The thickened sludge, in addition to a source of feedstock (i.e., biomass and/or nonbiomass feedstock) may also be processed by anaerobic fermentation/gasification to provide an energy supply for use, for example, for operation of wastewater treatment system 10.

According to another embodiment of the present invention, treatment system includes removal device 12 for removal of gross solids from the wastewater, aerating device 14 for reducing the BOD and/or COD of the wastewater and a reactor which contains a bacterial biofilm 18. The reactor includes a plurality of cells configured for operation on a predetermined drain fill cycle, which is, for example, between 0 and 40 days. The reactor according to this embodiment of the present invention is a bioreactor, a sequential batch reactor (SBR), a landfill, a membrane reactor, a fixed film reactor, a lagoon, a settling basin and/or a trickling filter. At least one wetland (i.e., a natural wetland or a constructed wetland) may be incorporated into the treatment system before and/or after the reactor.

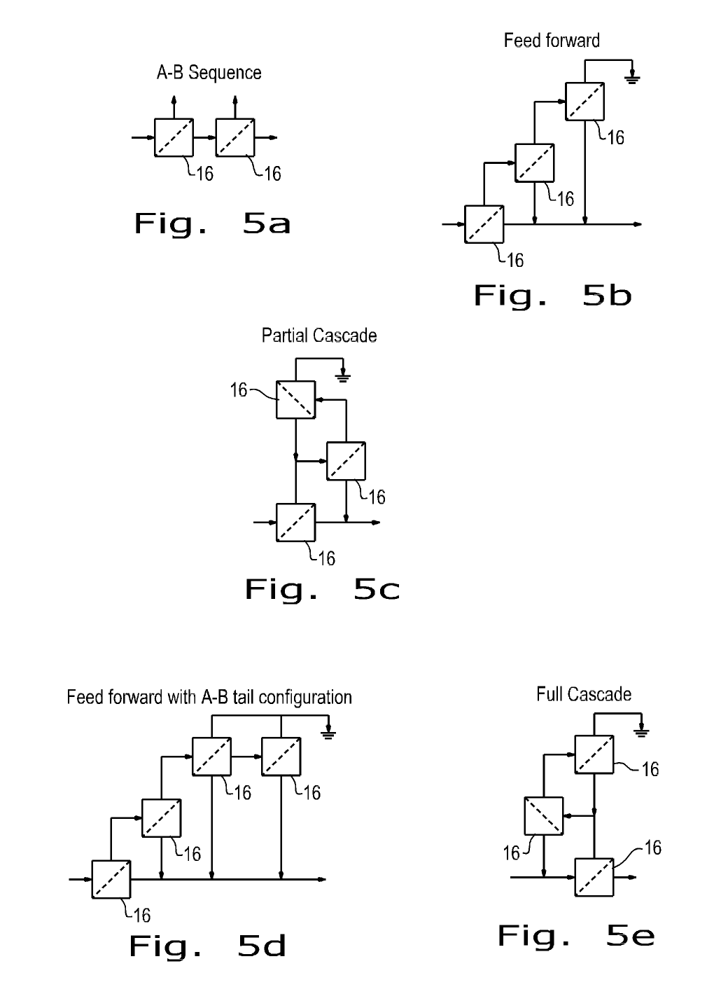

The reactor may further be stationary or mobile. The treatment system according to the present invention may further include a plurality of reactors, configured in series or in parallel, and may further include recirculation of the wastewater, as illustrated in FIGS. 5a-e. The reactor(s) according to the present invention may be operated in a pressure range between 0.1 and 100.0 atmospheres. The reactor(s) according to the present invention may further be operated in an environmental temperature range between approximately −40° F. and 210° F.; be located above-ground, below ground or a combination thereof; and have depths that are less than 15 feet. The individual reactor(s) may have a treatment cycle that is less than 72 hours and may contain a variety of materials including plastic, concrete-based material, rock, ceramic-based material, metal-based material or any combination thereof. The reactor(s) may also contain material or materials with iron and/or manganese or a combination thereof that is exposed to the wastewater. The reactors may further have a cover fill media sufficient to support the growth of plant life by providing a root zone. In this case, the cover fill media can serve as a bio-filtration media.

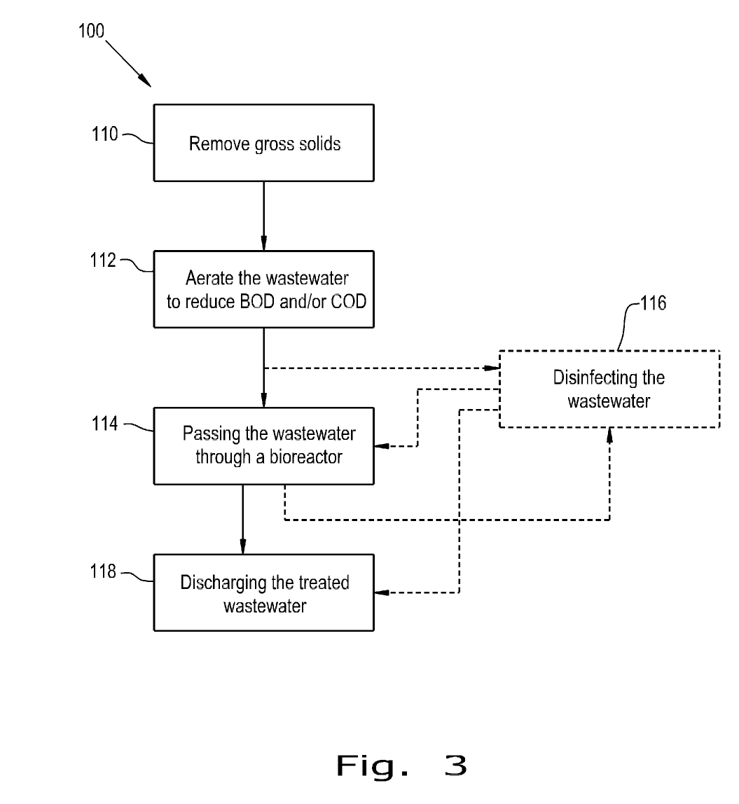

Referring now to FIG. 3, there is shown a flow chart of an embodiment of a method 100 for treatment of wastewater according to the present invention. As illustrated, method 100 includes step 110 of removing gross solids from the wastewater. Step 110 may be accomplished use of a raking, screening, settling, sedimentation, filtration and/or flocculation or any combination thereof. After step 110 of removing the gross solids, the wastewater is aerated at step 112 to reduce BOD and/or COD. The wastewater is then passed through a bioreactor at step 114, the bioreactor including at least one bacterial biofilm and a plurality of cells operating on a predetermined drain fill cycle. The treated wastewater may then be discharged, for example into an aquifer, or processed further for removal of additional contaminants.

Step 110 of removing gross solids may further comprise the step of utilizing a sludge thickening apparatus, for example a settling chamber, a screw press, a belt press, a centrifuge or any combination thereof.

Step 112 of aerating the wastewater to reduce BOD and/or COD is, for example, accomplished by utilizing a sequential batch reactor. The sequential batch reactor includes, for example, at least two chambers for removing nitrogen, phosphorous, hydrocarbons, pharmaceutical compounds and polychlorinated biphenyl (PCB) from the wastewater. Step 112 of aerating the wastewater may include the use of an aerated lagoon system, air activated mixing tanks and settling tanks.

Step 114 of passing the wastewater through a bioreactor may including passing the wastewater over a subsurface, horizontal flow fixed film, vegetated submerged bed (VSB) including at least one bacterial biofilm that is at least periodically submerged in the wastewater.

Advantageously, the present invention provides a device and method for treating wastewater which may further incorporate physical, chemical and/or biological pretreatment of the wastewater to remove gross solids and total suspended solids.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A treatment system for removing a plurality of pollutants from wastewater, the treatment system comprising:
a removal device for removing a plurality of gross solids from the wastewater;
an aeration device for reducing a biochemical oxygen demand (BOD) and a chemical oxygen demand (COD) of the wastewater; and
a bioreactor containing a bacterial biofilm, said bioreactor including a plurality of cells configured for operation on a predetermined drain fill cycle.

2. The treatment system according to claim 1, wherein said removal device is configured for at least one of raking, screening, settling, sedimentation, filtration and flocculation to remove said gross solids in the wastewater.

3. The treatment system according to claim 1, wherein said aeration device is configured for bubbling oxygen through the wastewater to reduce said BOD and said COD, said aeration device being one of a sequential batch reactor, a fixed film reactor, a trickling filter and a membrane filter.

4. The treatment system according to claim 3, wherein said aeration device is said sequential batch reactor and said sequential batch reactor includes a plurality of alternated reaction chambers.

5. The treatment system according to claim 1, wherein said aeration device is at least one of an aerated lagoon system, a plurality of air activated mixing tanks, and a settling tank.

6. The treatment system according to claim 1, wherein said bioreactor is a subsurface, horizontal flow fixed film, vegetated submerged bed (VSB) configured for operation of said drain fill cycle.

7. The treatment system according to claim 6, said bacterial biofilm being a plurality of bacterial biofilms and said VSB including a plurality of cells, each of said plurality of cells of said VSB including one of said plurality of bacterial biofilms.

8. The treatment system according to claim 1, said bacterial biofilm including an assemblage of a plurality of bacterial species.

9. The treatment system according to claim 8, wherein said plurality of bacterial species include at least one of obligate anaerobes, facultative aerobes, anaerobes and obligate anaerobes.

10. The treatment system according to claim 9, wherein said bacterial biofilm is a continuous linear biofilm apparatus including a plurality of contiguous segments configured to operate to control an oxidation-reduction potential (ORP) of said continuous linear biofilm and a metabolism of each of said plurality of bacterial species.

11. The treatment system according to claim 10, wherein said ORP is between approximately −400 millivolts (mV) and +400 mV.

12. The treatment system according to claim 1, further comprising at least one wetland, said wetland being one of a natural wetland and a constructed wetland, said at least one wetland being incorporated at least one of before and after said bioreactor.

13. The treatment system according to claim 1, said plurality of cells of said bioreactor is three cells including a first cell and a second cell for operating on an alternating fill and drain cycle and a third cell for remaining offline for a predetermined period of time.

14. The treatment system according to claim 13, wherein said predetermined time is between approximately 0 to 40 days.

15. A method of treating wastewater to remove a plurality of pollutants, the method comprising the steps of:
removing a plurality of gross solids from the wastewater;
aerating the wastewater to reduce a biochemical oxygen demand of the wastewater and a chemical oxygen demand (COD) of the wastewater; and
passing the wastewater through a bioreactor including at least one bacterial biofilm, said bioreactor including a plurality of cells operated on a predetermined drain fill cycle.

16. The method according to claim 15, further comprising the step of disinfecting the wastewater using one of a chemical treatment and an ultraviolet (UV) light treatment.

17. The method according to claim 15, wherein said aerating step further comprises utilizing a sequential batch reactor including at least two reaction chambers to remove at least one of nitrogen, phosphorous, hydrocarbons, pharmaceutical compounds and polychlorinated biphenyl (PCB) from the wastewater.

18. The method according to claim 15, wherein said aerating step further comprises using at least one of an aerated lagoon system, a plurality of air activated mixing tanks and a plurality of settling tanks.

19. The method according to claim 15, wherein said step of removing said plurality of gross solids further comprises utilizing a sludge thickening apparatus including at least one of a settling chamber, a screw press, a belt press and a centrifuge.

20. The method according to claim 15, wherein said step of passing the wastewater through said bioreactor includes passing the wastewater over a subsurface, horizontal flow fixed film, vegetated submerged bed including at least one cell including said at least one bacterial biofilm, said at least one bacterial biofilm being at least periodically submerged in the waste water.

21. A treatment system for removing a plurality of pollutants from wastewater, the treatment system comprising:
a removal device for removing a plurality of gross solids from the wastewater;
an aeration device for reducing a biochemical oxygen demand (BOD) and a chemical oxygen demand (COD) of the wastewater; and
a reactor containing a bacterial biofilm, said reactor including a plurality of cells configured for operation on a predetermined drain fill cycle.

22. The treatment system according to claim 21, wherein said reactor is one of a bioreactor, a sequential batch reactor (SBR), a landfill, a membrane reactor, a fixed film reactor, a lagoon, a settling basin and a trickling filter.

23. The treatment system according to claim 21, wherein at least one wetland is incorporated at least one of before and after said reactor, said at least one wetland being one of a natural wetland and a constructed wetland.
